(19) United States
(12) Patent Application Publication
(10) Pub. No.: US 2017/0337631 A1
(43) Pub. Date: Nov. 23, 2017

(54) METHOD AND APPARATUS FOR BENEFITS DISTRIBUTION

(71) Applicant: ELIZABETH FUZAYLOVA, STATEN ISLAND, NY (US)

(72) Inventor: ELIZABETH FUZAYLOVA, STATEN ISLAND, NY (US)

(21) Appl. No.: 15/157,098

(22) Filed: May 17, 2016

(51) Int. Cl. G06Q 40/06

(52) U.S. Cl. CPC G06Q 40/06

(57) ABSTRACT

An apparatus and a method for distributing benefits among a network are disclosed including: identifying a benefit club associated with a first subscriber to a service, the benefit club including one or more second subscribers to the service who have joined the service in response to an invitation from the first subscriber; identifying a first tangible value of the first subscriber; identifying one or more second tangible values of the one or more second subscribers, wherein each of the second tangible values corresponds to a different second subscriber; calculating a benefit for the first subscriber based on the first tangible value and the one or more second tangible values; calculating a benefit for each of the one or more second subscribers based on the first tangible value and respective ones of the second tangible values of the one or more second subscribers; and transmitting an indication of the benefit to the first subscriber over a communications network.

### BACKGROUND

### Technical Field

The present disclosure relates to electronic devices, in general, and, more particularly, to a method and apparatus for benefits distribution.

### Description of the Related Art

In recent years, Social network services continue to exponentially increase in popularity. Nearly two-thirds of American adults (65%) use social networking sites and the most well-known social networks have huge growing potential of user base: Facebook—1.55B monthly active users, Twitter—320M, Instagram 400M, Linkedin—400M. Users are leveraging a social network service to find and interact with other users, such as friends, business contacts, and so on. This interaction may be performed in a variety of ways, such as through messaging, photo sharing, posting videos, and so on.

However, proving the almost unlimited potential of social networking, such systems do not provide solid and predictable ways to distribute benefits and perks among selected subsets of social network using predefined rules and patterns. Accordingly, the need exists for new techniques for distributing benefits and perks among selected subsets of a social network.

### SUMMARY

The present disclosure addresses this need. According to one aspect of the disclosure, an apparatus is provided comprising: a memory coupled to at least one processor, the at least one processor being configured to: identify a benefit club associated with a first subscriber to a service, the benefit club including one or more second subscribers to the service who have joined the service in response to an invitation from the first subscriber; identify a first tangible value of the first subscriber; identify one or more second tangible values of the one or more second subscribers, wherein each of the second tangible values corresponds to a different second subscriber; calculate a benefit for the first subscriber based on the first tangible value and the one or more second tangible values calculate a benefit for each of the one or more second subscribers based on the first tangible value and respective ones of the second tangible values of the one or more second subscribers; and transmit an indication of the benefit to the first subscriber over a communications network. The benefits received by each of the subscribers may be bi-directional. For example, the benefit that the first subscriber receives may be based upon the tangible values assigned to the first subscriber as well as the tangible values of the second subscriber(s) who were invited by the first subscriber. Further, the benefits received by the second subscriber(s) or in this example the invitees of the first subscriber are based on their own respective tangible values and the tangible value of the first subscriber who invited them.

According to another aspect of the disclosure, a method is provided comprising: identifying, by at least one processor, a benefit club associated with a first subscriber to a service, the benefit club including one or more second subscribers to the service who have joined the service in response to an invitation from the first subscriber; identifying, by the at least one process, a first tangible value of the first subscriber; identifying, by the at least one processor, one or more second tangible values of the one or more second subscribers, wherein each of the second tangible values corresponds to a different second subscriber; calculating, by the at least one processor, a benefit for the first subscriber based on the first tangible value and the one or more second tangible values; calculating, by the at least one processor, a benefit for each of the one or more second subscribers based on the first tangible value and respective ones of the second tangible values of the one or more second subscribers; and transmitting, by the at least one processor, an indication of the benefit to the first subscriber over a communications network.

It is to be understood that benefits to each subscriber may be ‘bi-directional’ meaning that a subscriber's benefits are based upon a value assigned to the subscriber, as well as, values assigned to that subscriber's inviter (i.e., the subscriber who invited the subscriber) and that subscriber's invitees (i.e., those subscribers who the subscriber invited). Benefits a network is determined based upon the direct connections of the subscribers. For example, if subscriber A invites both subscriber B and C, subscribers A benefits from subscriber B and subscriber B benefits from subscriber A and subscriber A benefits from subscriber C and subscriber C benefits from subscriber A, but the subscribers B and C do not have a direct connection and thus do not benefit from each other.

These and other aspects of the present disclosure are more fully described hereinbelow with reference to the accompanying figures.

### BRIEF DESCRIPTION OF THE DRAWINGS

FIG. 1 is a diagram of an example of a system, according to aspects of the disclosure;

FIG. 2 is a diagram of an example of a client device, according to aspects of the disclosure;

FIG. 3 is a diagram of an example of a database record, according to aspects of the disclosure;

FIG. 4 is a diagram of an example of a database including the record of FIG. 3, according to aspects of the disclosure;

FIG. 5 is a diagram of a graph that is generated based on the content of the database of FIG. 4, according to aspects of the disclosure;

FIG. 6A is a diagram of a sub-graph that is generated based on the graph of FIG. 5, according to aspects of the disclosure;

FIG. 6B is a diagram of a sub-graph that is generated based on the graph of FIG. 5, according to aspects of the disclosure;

FIG. 6C is a diagram of a sub-graph that is generated based on the graph of FIG. 5, according to aspects of the disclosure; and

FIG. 7 is a flowchart of an example of a process for benefits distribution, according to aspects of the disclosure.

### DETAILED DESCRIPTION

Reference will now be made in detail to embodiments of the invention. Wherever possible, same or similar reference numerals are used in the drawings and the description to refer to the same or like parts or steps. The drawings are in simplified form and are provided only for illustrative purposes.

According to aspects of the disclosure, a technique is provided for distributing benefits in a network of socially connected consumers. Benefits could be presented in the form of discounts for particular services, e.g. discount on a management fee for managing a portfolio of securities. Additionally or alternatively, the benefits may include any suitable type of monetary or non-monetary reward, rebate, or discount that is provided to a particular consumer.

According to aspects of the disclosure, a consumer may join a particular commercial service. The commercial service may include any suitable type of electronic service, such as a banking service, a stock portfolio management service, an online store, etc. After joining the service, the consumer may invite other consumers to join the service. When another consumer joins the service in response to the invitation to the former consumer, the other consumer is registered by the system as the former's consumer's invitee.

According to aspects of the disclosure, the consumer may be associated with a tangible value (TV). The consumer's tangible value may include the total size of the consumer's stock portfolio that is managed by the service, a total size of the consumer's savings account, a total amount of purchases made by the consumer, and/or any other suitable type of metric that indicates the consumer's investment with the service.

According to aspects of the disclosure, the consumer may be associated with a benefit club that is uniquely associated with the consumer. For example, and without limitation, the benefit club may include the consumer and all of the consumer's invitees. As is further discussed below, the commercial service may provide a benefit to the consumer based on a characteristic of the consumer's club. In other words, in some implementations, a consumer's club may serve as a basis for distributing a benefit to that consumer.

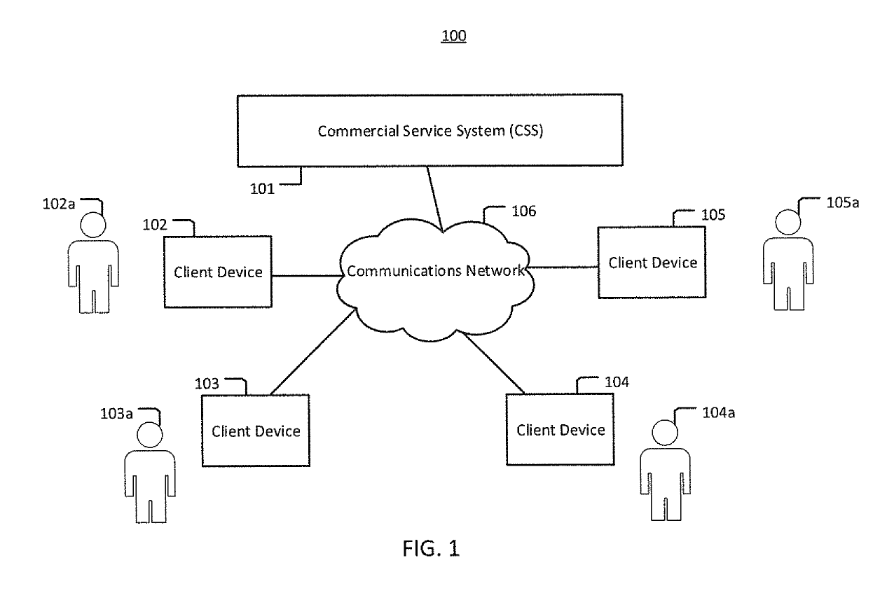

FIG. 1 is a diagram of an example of a system 100, according to aspects of the disclosure. As illustrated, the system 100 includes a commercial service system (CSS) 101, client devices 102-105, and a communications network 106.

According to aspects of the disclosure, the CSS 101 may include one or more servers (e.g., a single server, a server farm, etc.) that are used to provide a commercial service (e.g., a stock portfolio management service). In operation, CSS 101 may maintain a consumer profile database (CDB) that includes records for the consumers who have joined the commercial service (e.g., the members of the service). Additionally or alternatively, the CSS may include hardware and/or software for performing stock trading transactions and/or any other suitable type of transaction on behalf of the consumers who have joined the service.

The client devices 102-105 may include any suitable type of computing device. For example, any of the client devices 102-105 may include a smartphone, a desktop computer, a laptop, a gaming console, a digital media player, etc. The communications network 106 may include one or more of a local area network (LAN), a wide area network (WAN), a wireless network (e.g., 802.11, 4G, etc.), and or any other suitable type of network. Each of the client devices 102-105 may be associated with a respective user 102a-105a who is a member of the service.

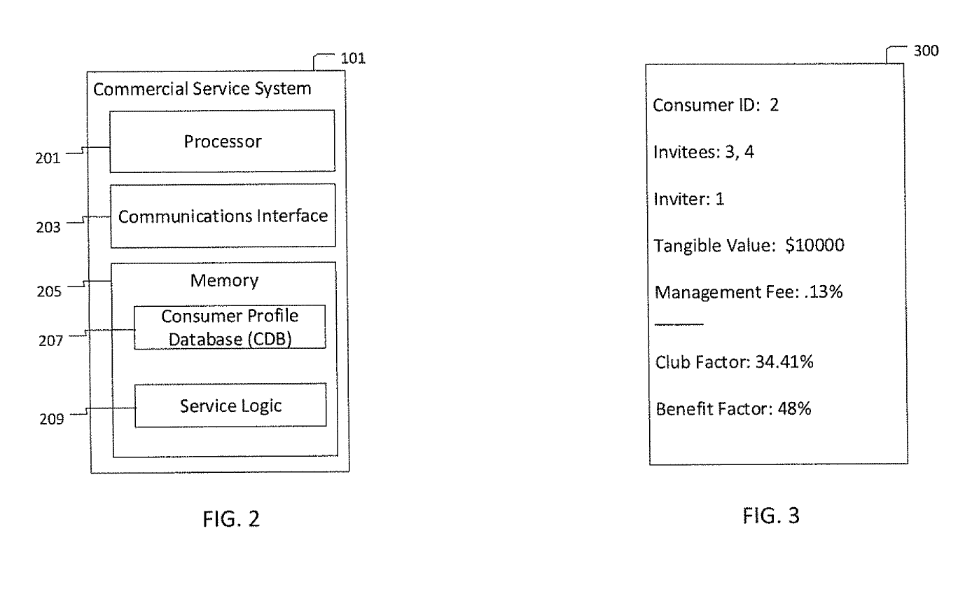

FIG. 2 is a diagram of an example of the commercial service system (CSS) 101, according to aspects of the disclosure. As illustrated, the CSS 101 includes a processor 201, a communications interface 203, and a memory 205. According to aspects of the disclosure, the processor 201 may include any suitable type of processing circuitry, such as a general-purpose processor (e.g., an ARM-based processor), an application-specific integrated circuit (ASIC), or a Field-Programmable Gate Array (FPGA). The communications interface 203 may include any suitable type of communications interface, such as a WiFi interface, an Ethernet interface, a Long-Term Evolution (LTE) interface, a Bluetooth Interface, an Infrared interface, etc. The memory 205 may include any suitable type of volatile and non-volatile memory, such as random-access memory (RAM), read-only memory (ROM), a hard disk (HD), a solid state drive (SSD), a CD-ROM, flash memory, cloud storage, or network accessible storage (NAS). In some implementations, the memory 205 may store a consumer profile database (CDB) 207 and service logic 209.

The CDB 207 may include any suitable type of data structure that is arranged to store one or more consumer profile records. By way of example, the CDB 207 may include one or more of a file system folder, a relational database, an SQL database, etc. Each profile record may include a data structure containing consumer profile information. An example of a consumer profile record is provided further below with respect to FIG. 3

The service logic 209 may include one or more of a load balancer, a service frontend that is arranged to interface with instances of a mobile application (e.g. an App) that are executed on the client devices 102-105, and a service backend arranged to provide the particular service. For example, the service backend may be arranged to provide various portfolio management functions, such as buying stock, selling of stock, generating of portfolio reports. Additionally or alternatively, as another example, the service backend may implement an online store, a shopping cart, a billing system, etc.

Although in this example the CSS 101 is presented as an integral device, in some implementations the CSS 101 may be implemented as a network of computers, and/or a server farm. For instance, the CDB 207 and the service logic 209 may be hosted on different computers. Moreover, any of the CDB 207 and the service logic 209 may be hosted on multiple computers.

FIG. 3 is a diagram of an example of a consumer database record 300 that is stored in the consumer profile database (CDB), according to aspects of the disclosure. As illustrated, the consumer database record for a given consumer may include an ID corresponding to the consumer. In addition, the consumer database may include identification of each of the consumer's invitees, an indication of the consumer's inviter, an indication of the consumer's tangible value, and an indication of the management fee that is charged to the user.

The consumer ID may include any number and/or alphanumerical string that is capable of identifying the consumer among other subscribers to the commercial service. The consumer may be a physical person, a business entity, and/or any other suitable type of entity.

The tangible value may include any suitable type of metric that indicates the amount of investment of the consumer with the commercial service. In the present example, the tangible value indicates the total value of a stock portfolio which belongs to the consumer and is managed by the commercial service on the consumer's behalf. However, in some implementations, the tangible value may be based at least in part on the total value of a savings account that the consumer has with the commercial service, the total amount of purchases made by the user from the commercial service, etc.

The invitees (e.g., consumer 3 and consumer 4) may be consumers who have joined the commercial service in response to an invitation from the consumer to whom the consumer database record belongs (e.g., consumer 2). The management fee may be the charge incurred by the consumer for using the commercial service. In the present example, the management fee is specified as a percentage of the consumer's tangible value. However, in some implementations, the management fee may be specified as a fixed sum.

The inviter (e.g., consumer 1) may be the consumer who invited the consumer to whom the database record belongs (e.g., consumer 2) to join (e.g., subscribe to) the commercial service. In other words, a given consumer may be an inviter of another consumer, if the other consumer has joined the commercial service in response to an invitation from the given consumer.

Additionally or alternatively, in some implementations, the consumer database record 300 may include an indication of a club factor and a benefit factor that is associated with the consumer to whom the consumer database record 300 belongs. As is further discussed below, the club factor and the benefit factor may be used to calculate the management fee that is charged to the consumer.

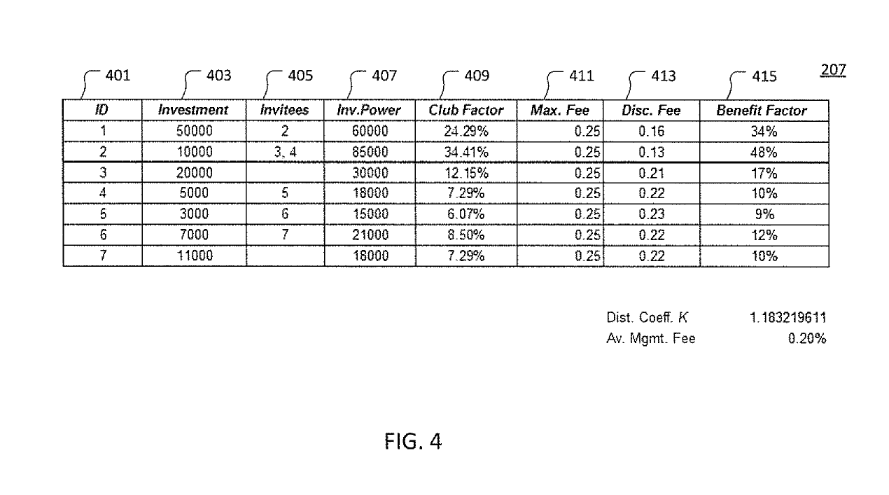

FIG. 4 is a diagram of an example of the consumer profile database (CDB) 207. In the example of FIG. 4, the CDB 207 is implemented as a tabular data structure which contains information associated with consumers 1-7. Consumers 1-7 may be subscribers to the commercial service, and each row in the data structure may correspond to a different one of them. As illustrated, the CDB 207 may include columns 401-415 which include various types of information associated with the consumers.

More particularly, column 401 identifies the ID of each of consumers 1-7. Column 403 lists the tangible value of each of the consumers. Column 405 includes indications of each consumer's respective invitees. For example, column 405 indicates that consumer consumers 3 and 4 have joined the commercial network in response to an invitation from consumer 2.

Column 407 identifies the buying power of each of the consumers. The buying power a given consumer may be calculated based on the sum of the given consumer's tangible value and the tangible values of the given consumer's invitees. The buying power of a given consumer may be used to calculate that consumer's club factor.

Column 409 identifies a club factor associated with each of the consumers. According to aspects of the disclosure, the club factor may be a metric which is used to calculate each consumer's benefit.

Column 411 identifies the maximum management fee that is chargeable to each of consumers 1-7. In the present example, each of consumers 1-7 is associated with the same maximum management fee, however in some implementations, any of consumers 1-7 may be associated with a different management fee than at least one of the remaining consumers.

Column 413 identifies the management fee that is charged to each of consumers 1-7. Column 415 identifies the benefit that is accorded to each of consumers 1-7. In the present example, the benefit that is awarded to each consumer is a discount over that user's respective maximum fee. For example, columns 413 and 415 indicate that the maximum management fee that is chargeable to consumer 2 is discounted by 48 percent to charge consumer 2 a 0.13% management fee.

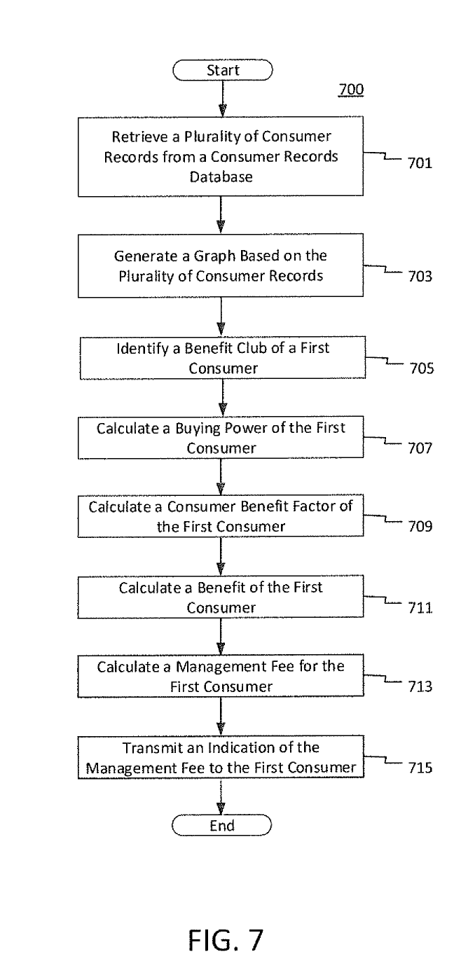

According to aspects of the disclosure, the average management fee for consumers 1-7 satisfies a predetermined threshold. For example, the average management fee may be equal 0.2%. As is discussed further below with respect to FIG. 7, this is achieved by applying a predetermined distribution coefficient k to the consumer's respective club factors. In the present example, the distribution coefficient k is equal to 1.1832.

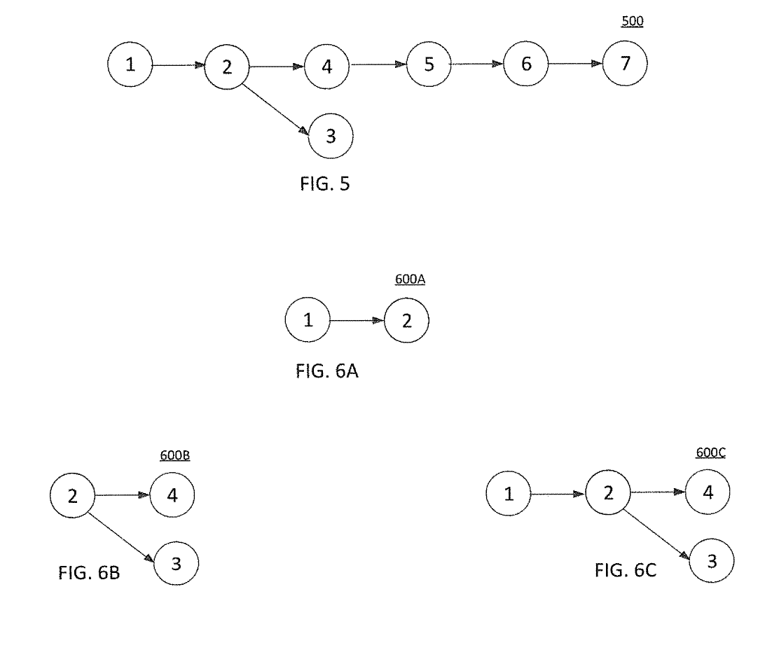

FIG. 5 is a diagram of an example of a graph 500 illustrating the relationships between consumers 1-7. Graph 500 may be generated by the CSS 101 based on information that is stored in CDB 207.

As illustrated, graph 500 is a directional acyclic graph (DAG). Each node in the graph 500 corresponds to a different one of consumers 1-7. Each edge in the graph that spans between a parent node and a child node indicates that consumer corresponding to the child node is an invitee of the consumer corresponding to the parent node.

In the present example, the graph 500 indicates, that consumer 2 is an invitee of consumer 1. Furthermore, the graph 500 indicates that consumers 3 and 4 are invitees of consumer 2. And still furthermore, the graph 500 indicates that: consumer 5 is an invitee of consumer 4; consumer 6 is an invitee of consumer 5; and consumer 7 is an invitee of consumer 6. Moreover, the graph 500 indicates that consumers 3 and 7 have no invitees of their own.

FIGS. 6A-B illustrate different examples of benefit clubs that correspond to consumers 1 and 2 respectively. Each of the benefit clubs may be determined by the CSS 101 based on the graph 500. According to aspects of the disclosure, the benefit club for a given consumer may include the consumer as well as any other consumer that is located at a predetermined distance downstream from the given consumer in the graph 500, such that a path exists between the given consumer and the other consumer. Optionally, in some implementations, the benefit club of the given consumer may also include the given consumer's inviter.

For example, the predetermined distance may be any suitable type of distance, such a distance of 1 edge and a distance of 2 edges. When the predetermined distance is one edge, the benefit club of a given consumer may include the given consumer and all of the given consumer's invitees. However, when the predetermined distance is two edges, the benefit club may additionally include the invitees of the given consumer's invitees.

More particularly, FIG. 6A illustrates an example of a benefit club 600A of consumer 1. As illustrated, the benefit club 600A may include consumer 1 and consumer 2. FIG. 6B illustrates an example of a benefit club 600B for consumer 2. As illustrated, the benefit club 600B may include consumer 2 and consumers 3 and 4. FIG. 6C illustrates another example of benefit club for consumer 2. As illustrated, the benefit club 600C may also include the inviter of consumer 2 (e.g., consumer 1) in addition to consumer 2's invitees (e.g., consumers 3 and 4).

FIG. 7 is a flowchart of an example of a process 700 for calculating a benefit that is awarded to a first consumer who is subscribed to the commercial service provided by the CSS 101, according to aspects of the disclosure. The process 700 may be executed by the CSS 101.

At operation 701, a plurality of consumer records is received from the CDB 207. The plurality of records may include the records of all subscribers to the commercial service or the records of only a portion of the subscribers. In some implementations, the consumer records may be the same or similar to the consumer record 300 that is shown in FIG. 3.

At operation 703, the graph 500 is generated based on the plurality of records.

At operation 705, a benefit club corresponding to the first consumer is determined. The benefit club may be determined based on information stored in CDB 207 and/or the graph 500. In some implementations, the benefit club for the first consumer may include the first consumer, and all or some of the first consumer's invitees. Put differently, the benefit club for the first consumer may include the first consumer as well as all any other consumer that is located at a predetermined depth downstream from the first consumer in the graph 500, such that a path exists between the first consumer and the other consumer. In some implementations, the benefit club of the first consumer may also include the first consumer's inviter.

In some implementations, the benefit club corresponding to the first consumer may be determined by extracting a tree from the graph in which a first node that corresponds to the first consumer (or the first consumer's inviter) is the root. According to aspects of the disclosure, the tree may have a predetermined depth and/or depth that is entered manually by a system administrator into the CSS. The benefit club may thus consist of the consumers corresponding to the nodes of the tree. Thus, in some implementations, the benefit club may be determined by extracting a tree from the graph 500, as discussed above, and identifying the consumers that correspond to the nodes in the tree.

At operation 707, consumer buying power is calculated for the first consumer. According to aspects of the disclosure, the consumer buying power may equal to the sum of the tangible values of all members of the benefit club of the first consumer. For example, the consumer buying power may be calculated by using the following formula:

$$Consumer Buying {Power}_{i} = \{ \begin{matrix}{TV}_{i} + {\sum }_{j}^{ } {TV}_{j} , where ( i , j ) edge exists \\ 0 , if i does not have any linked nodes\end{matrix} \} , \qquad Eq . 1$$

where TVᵢ is the tangible value of the first consumer, TVⱼ is the tangible value of consumer/that is connected by an edge to the first consumer in the graph 500. As noted above, in some implementations, every consumer j may be an invitee of the first consumer.

At operation 709, a club factor for the first consumer is calculated. The club factor may be calculated by normalizing the consumer buying power of the first consumer across a set of N consumers that are subscribed to the commercial service. The set may include all subscribers to the commercial service, and or a portion of all subscribers to the commercial service. Additionally or alternatively, the set may include all members of the first consumer's benefit club except for the first consumer. In some implementations, the club factor may be calculated according to Equation 2 below:

$$Club {Factor}_{i} = \frac{Consumer Buying {Power}_{i}}{\sum Consumer Buying {Power}_{m}} , m ∈ 1 … N , \qquad Eq . 2$$

where Club Factorᵢ is the club factor for the first consumer, Consumer Buying Powerᵢ is the consumer buying power of the first consumer, and Consumer Buying Powerₘ is the consumer buying power for consumer in from the set of N consumers.

At operation 711, a benefit for the first consumer is calculated based on the consumer's club factor. As noted above, in some implementations, the benefit may be a discount over a maximum management fee that is chargeable to the user. In some implementations, the benefit may be calculated according to Equation 3 below:

Benefitᵢ=Club Factorᵢ×k², Eq. 3

where Benefit; is the benefit of the first consumer, and k is a distribution coefficient which ensures that the average management fee of the set of N consumers is equal to or otherwise approaches a predetermined value (e.g., 0.2%).

In some implementations, the distribution coefficient k may be derived from the solution of the following optimization problem:

f (k)→S, where S is an average discounted management fee

$$f ( k ) = \frac{{\sum }_{j}^{ } {Benefit}_{j} ( k )}{N} , where 0 < {Benefit}_{j} ( k ) < 1$$

In operation 713, the management fee for the first consumer is calculated. According to aspects of the disclosure, the management fee for the first consumer is calculated based on the benefit. For example, the benefit may be deducted from a maximum management fee that is associated with the first consumer in order to calculate the management fee that is actually charged to the first consumer.

In operation 715, an indication of the management fee is transmitted from the CSS 101 to the client device of the first consumer. For example, the indication may be transmitted over the network 106.

FIGS. 1-7 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

Having described at least one of the preferred embodiments of the present invention with reference to the accompanying drawings, it will be apparent to those of skill in the art that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An apparatus comprising: a memory coupled to at least one processor, the at least one processor being configured to:
identify a benefit club associated with a first subscriber to a service, the benefit club including one or more second subscribers to the service who have joined the service in response to an invitation from the first subscriber;
identify a first tangible value of the first subscriber;
identify one or more second tangible values of the one or more second subscribers, wherein each of the second tangible values corresponds to a different second subscriber;
calculate a benefit for the first subscriber based on the first tangible value and the one or more second tangible values;
calculate a benefit for each of the one or more second subscribers based on the first tangible value and respective ones of the second tangible values of the one or more second subscribers; and
transmit an indication of the benefit to the first subscriber over a communications network.

2. The apparatus of claim 1, wherein:
the service includes a stock portfolio management service,
the first tangible value includes a total value of a stock portfolio belonging to the first subscriber; and
each of the second tangible values includes a total value of a stock portfolio belonging to a different one of the second subscribers.

3. The apparatus of claim 1, wherein the benefit includes a discount over a predetermined management fee that is charged to the first subscriber.

4. The apparatus of claim 1, the at least one processor being further configured to:
identify a plurality of subscribers of the service;
generate a graph corresponding to the plurality of subscribers that includes a plurality of nodes, and an edge is inserted between any pair of nodes in which a subscriber that corresponds to one of the nodes in the pair is an invitee of another subscriber corresponding to the other of the nodes in the pair,
wherein the benefit club of the first subscriber is identified based on the graph.

5. The apparatus of claim 4, wherein identifying the benefit club includes extracting a tree having predetermined depth from the graph, the tree having a first root node corresponding to the first subscriber and one or more second nodes corresponding to the one or more second subscribers.

6. The apparatus of claim 1, wherein the benefit is calculated based on a buying power of the first subscriber, the buying power being calculated according to the formula:
$${TV}_{1} + {\sum }_{j}^{ } {TV}_{j} ,$$
wherein TV₁ is the first tangible value of the first subscriber, and TVⱼ is the second tangible value of each of the one or more second subscribers.

7. The apparatus of claim 6, wherein the benefit is calculated based on a club factor associated with the first subscriber, the club factor being calculated according to the formula:
$$Club {Factor}_{i} = \frac{Consumer Buying {Power}_{i}}{\sum Consumer Buying {Power}_{m}} , m ∈ 1 … N ,$$
wherein Club Factor₁ is the club factor associated with the first subscriber, Consumer Buying Power₁ is the buying power of the first subscriber, Consumer Buying Powerₘ is buying power of a given one of the one or more second subscribers, and N is a count of the one or more second subscribers.

8. The apparatus of claim 1, wherein the benefit for the first subscriber is calculated based on a distribution coefficient K in order to cause an average benefit value for a plurality of subscribers to meet a predetermined threshold.

9. A method comprising:
identifying, by at least one processor, a benefit club associated with a first subscriber to a service, the benefit club including one or more second subscribers to the service who have joined the service in response to an invitation from the first subscriber;
identifying, by the at least one process, a first tangible value of the first subscriber;
identifying, by the at least one processor, one or more second tangible values of the one or more second subscribers, wherein each of the second tangible values corresponds to a different second subscriber;
calculating, by the at least one processor, a benefit for the first subscriber based on the first tangible value and the one or more second tangible values;
calculating, by the at least one processor, a benefit for each of the one or more second subscribers based on the first tangible value and respective ones of the second tangible values of the one or more second subscribers; and
transmitting, by the at least one processor, an indication of the benefit to the first subscriber over a communications network.

10. The method of claim 9, wherein:
the service includes a stock portfolio management service,
the first tangible value includes a total value of a stock portfolio belonging to the first subscriber; and
each of the second tangible values includes a total value of a stock portfolio belonging to a different one of the second subscribers.

11. The method of claim 9, wherein the benefit includes a discount over a predetermined management fee that is charged to the first subscriber.

12. The method of claim 9, further comprising:
identifying a plurality of subscribers of the service;
generating a graph corresponding to the plurality of subscribers that includes a plurality of nodes, and an edge is inserted between any pair of nodes in which a subscriber that corresponds to one of the nodes in the pair is an invitee of another subscriber corresponding to the other of the nodes in the pair,
wherein the benefit club of the first subscriber is identified based on the graph.

13. The method of claim 12, wherein identifying the benefit club includes extracting a tree having predetermined depth from the graph, the tree having a first root node corresponding to the first subscriber and one or more second nodes corresponding to the one or more second subscribers.

14. The method of claim 9, wherein the benefit is calculated based on a buying power of the first subscriber, the buying power being calculated according to the formula:
$${TV}_{i} + {\sum }_{j}^{ } {TV}_{j} ,$$
wherein TV₁ is the first tangible value of the first subscriber, and TVⱼ is the second tangible value of each of the one or more second subscribers.

15. The method of claim 14, wherein the benefit is calculated based on a club factor associated with the first subscriber, the club factor being calculated according to the formula:
$$Club {Factor}_{i} = \frac{Consumer Buying {Power}_{i}}{\sum Consumer Buying {Power}_{m}} , m ∈ 1 … N ,$$
wherein Club Factor₁ is the club factor associated with the first subscriber, Consumer Buying Power₁ is the buying power of the first subscriber, Consumer Buying Powerₘ is buying power of a given one of the one or more second subscribers, and N is a count of the one or more second subscribers.

16. The method of claim 9, wherein the benefit for the first subscriber is calculated based on a distribution coefficient K in order to cause an average benefit value for a plurality of subscribers to meet a predetermined threshold.
